(19) United States
(12) Patent Application Publication
(10) Pub. No.: US 2003/0041010 A1
(43) Pub. Date: Feb. 27, 2003

(54) Online bidding for contracts

(76) Inventor: Mark Yonao-Cowan, Ottawa (CA)

Correspondence Address: Shapiro Cohen, P.O. Box 3440, Station D, Ottawa, ON, K1P 6P1, CA

(21) Appl. No.: 09/934,848

(22) Filed: Aug. 23, 2001

(51) Int. Cl. G06F 17/60

(52) U.S. Cl. 705/37

(57) ABSTRACT

Methods and apparatus for conducting a sealed bid auction. For lowest winning bid auctions, a winning pool is created by determining the lowest bids and increasing these bids to the second lowest values. The second lowest bids and the increased lowest bid form the winning pool. A single winner is then chosen from this winning pool. This method is applied in an online sealed bid auction system for bidding on contracts. A server receives a contract up for bid and posts the details of the contract to potential bidders. Bidders then post bids for the contract along with their online profile. At the end of the bidding period the lowest bids are increased to the second lowest bid to form the winning pool. The entity that puts the contract up for bids is given the amount of the second lowest bid and the profiles of the bidders in the winning pool. Based on the profile or on a randomly generated decision, one of the bidders is chosen.

### FIELD OF INVENTION

The present invention relates to auctions and more particularly to online auctions for translation services.

### BACKGROUND TO THE INVENTION

The concept of auctions is old, as is the concept of auctioning of contracts for services. The auctioning of contracts for services derives from the idea that whoever puts in the lowest bid or the cheapest price for a given contract will theoretically win the bidding, and hence the contract.

However, this process is flawed. It is susceptible to bid rigging and underbidding. What may happen is that a potential contractor will price the contract at such a low price so that he or she can put in the lowest bid. This unfortunately leads to underbidding, leading to either a shoddy job or cost overruns. It may also lead to bid rigging which is produced by a collusion between a contractor and the contractee. The contractor will put in a low bid and the contractee, knowing beforehand that the contractor will put in a low bid, will choose that specific contractor for the job. Because of this, other bidding contracts are shut out of the process and this can lead to higher charges for the contract.

Recently technological advances have updated the auction process for the twenty-first century. Popular web sites such as eBay™ and other online auction sites allow individuals to participate in online auctions. Unfortunately, none of these auction sites addresses the concerns laid out above for contracting services. Current web sites are generally geared toward auctions that award the object being auctioned off to the highest bidder. Other auction sites that award the item or service being auctioned off to the lowest bidder are still subject to the problems laid out above.

Some efforts have been made to resolve the above concerns. However, none of them provide a complete solution. Some of these efforts are as follows:

U.S. Pat. No. 5,243,515 issued to Lee discloses how secret bids can be entered and received by an auction system using telephone lines. The bidders can enter their bids by voice using telephones and, after a certain time interval, bidders receive a report comparing the bids entered. The report does not disclose the identity of the bidders. Awarding the contract being bid for to someone other than a winning bidder is not discussed in the patent.

U.S. Pat. No. 5,640,569 issued to Miller et al. discusses a bidding system for computer resources in a distributed computing system. This patent discloses a second-price sealed bid auction where the highest bidder wins the bidding but is assessed the cost of the second highest bid. In the disclosure, the bidder with the highest bid wins but the cost assessment is based on the difference between the highest bid price and the second highest bid price. The winner of the auction is still the highest winning bidder.

U.S. Pat. No. 6,151,589 issued to Aggarwal et al. discloses an auction system with dynamically adjusted time intervals. Bidders enter not only a bid amount but a time interval in which that bid is valid. The system can then determine when would be the most opportune times to conduct the auction based on the bid amounts entered along with time intervals in which the bids are valid. Bidders with the highest bid during the auctions win. Again, awarding the item to someone other than the highest winner is not discussed.

PCT Application WO 00/57323 applied for by Semret et al. discusses resource allocation using a second price auction technique. Essentially, a winning bidder is given the resources it needs but is charged the second highest bid. The second highest bidder is given any leftover resources and is charged a price based on the lower, non-winning bids. This application awards resources to not only the winning bidder but also to the second highest bidder. However, the price that these two bidders pay is not the same—the winning bidder pays a higher price than the second highest bidder.

PCT Application WO 00/58896 applied for by Kinney et al discloses using a system to present bids in present value terms. A bid for a contract, given in present money amounts, is extrapolated to its complete lifetime and the value of that bid is presented in present value terms. Thus, a bid of $500,000 a year for a 4 year contract is converted to present value terms yielding a present value of $1,681,889. In normal systems, the 4 year contract may seem to be worth $2,000,000 over 4 years but, by converting the contract to net present value terms, its true present value of about $ 1.681 million is revealed. The application only discusses the net present value system and leaves the awarding of the contract to the entity requiring the work.

PCT Application WO 00/65505 applied for by McCagg et al discloses multiple types of auctions. The application discloses using a “first come-first served” auction, a standard auction, or a “highest-sealed-bid” auction. The seller configures the auction, including the type of auction desired, using a website. A software module receives bids and determines the winner based on the type of auction desired by the seller and the bids entered. For the highest sealed bid auction, the seller may elect to post a minimum bid. The application only contemplates awarding the item being bid for to the person entering the highest bid in the highest sealed bid auction.

PCT Application WO 00/75848 applied for by Kinney et al. discusses indexed bidding in an auction. The seller chooses one or more criteria to be used as an index and all bids entered are indexed to these criteria. The bidders can then monitor the index (such as the future price of a commodity) so that they can bid accordingly. Again, only those entering the highest indexed bids are awarded the item or contract.

EPO Application 1 054 333 applied for by Carpenter et al. discloses a computer system for the posting of jobs open for bids. Suppliers bidding on the jobs can collaborate with other suppliers online by subcontracting them to perform specific portions of the job. The collaborated suppliers then enter a bid for the contract. The entity requesting proposals from suppliers can then examine the bids and the work history of the suppliers/collaborated suppliers online to determine who is awarded the contract. The application does not disclose a system relating to the manner of awarding the jobs based on the bids.

Canadian application 2 180 995 applied for by Godin, et al. discloses a time based decreasing price auction. A seller run online auction for multiple non-unique items is opened and a price is posted. As time elapses, the posted price decreases. Bidders then purchase quantities of the item up for bid at the price posted when the bid is received. As time elapses and the price decreases, the demand for the item increases as the supply of the item decreases. Bidders who have already purchased the item are removed from the pool of allowable bidders after their purchase. Bidders can wait for the posted price to keep decreasing but they run the risk of having the supply of the item exhausted before they enter their bid. Bidders are not allowed to enter their own bids but are only allowed to purchase at the posted price.

Canadian application 2 282 173 applied for by Seymour et al uses genetic algorithms (programs which evolve and adapt) to generate bidding and selling strategies for both buying bidders and sellers. The application describes the “Vickrey” auction where the item up for auction is sold to the highest bidder at the second highest bid price in a sealed bid auction.

Clearly, none of the above solves the problem associated with the lowest winning bid auction. There is therefore a need for a new method of conducting sealed bid auctions that avoids the problems laid out above, but also takes into account the needs of current emerging technologies.

### SUMMARY OF THE INVENTION

The present invention provides methods and apparatus for conducting a sealed bid auction. For lowest winning bid auctions, a winning pool is created by determining the lowest bids and increasing these bids to the second lowest values. The second lowest bids and the increased lowest bid form the winning pool. A single winner is then chosen from this winning pool. This method is applied in an online sealed bid auction system for bidding on contracts. A server receives a contract up for bid and posts the details of the contract to potential bidders. Bidders then post bids for the contract along with their online profile. At the end of the bidding period the lowest bids are increased to the second lowest bid to form the winning pool. The entity that puts the contract up for bids is given the amount of the second lowest bid and the profiles of the bidders in the winning pool. Based on the profile or on a randomly generated decision, one of the bidders is chosen.

In a first embodiment, the invention provides a method of conducting a sealed bid auction, the method comprising:

(a) receiving the sealed bids prior to a bidding deadline;

(b) at or after said bidding deadline, creating a winner pool by:

(b1) determining which of said sealed bids is lowest,

(b2) determining which of said sealed bids is second lowest,

(b3) increasing lowest bids to an amount equal to second lowest bids, said winner pool being composed of said second lowest bids and said increased lowest bids,

(c) choosing a single winner from said winner pool.

In a second embodiment, the invention provides a method of conducting a sealed bid auction, the method comprising:

(a) receiving the sealed bids prior to a bidding deadline;

(b) at or after said bidding deadline, creating a winner pool by:

(b1) determining which of said sealed bids is highest,

(b2) determining which of said sealed bids is second highest,

(b3) decreasing highest bids to an amount equal to second highest bids, said winner pool being composed of said second highest bids and said decreased highest bids,

(c) choosing a single winner from said winner pool.

In a third embodiment, the invention provides an online system for conducting lowest sealed bid auctions, the system comprising:

a computer server for monitoring and executing a lowest sealed bid auction,

a plurality of bidder computers in communication with said server, each of said bidder computers transmitting at least one bid to said server for said auction,

at least one client computer in communication with said server, said at least one client computer providing said server computer data regarding said auction and data regarding an item or contract up for bids,

wherein

said server creates a winner pool from said bidder computers based on amounts of bids received from said bidder computers and said client computer chooses an auction winner from said winner pool, and

each bidder computer is unaware of the bid amounts transmitted by other bidder computers.

In a fourth embodiment, the invention provides a computer server for conducting an online sealed bid auction, said server containing computer readable and computer executable code for:

(a) receiving sealed bids from bidder computers prior to a bidding deadline,

(b) at or after said bidding deadline, creating a winner pool by:

(b1) determining which of said sealed bids is lowest,

(b2) determining which of said sealed bids is second lowest,

(b3) increasing lowest bids to an amount equal to second lowest bids, said winner pool being comprised of said second lowest bids and said increased lowest bids,

(c) choosing a single winner from said winner pool.

### BRIEF DESCRIPTION OF THE DRAWINGS

A better understanding of the invention may be obtained by reading the detailed description of the invention below, in conjunction with the following drawings, in which:

FIG. 1 is a block diagram of a system on which the invention can be practised,

FIG. 2 is a flowchart detailing the steps in a method according to the invention, and

FIG. 3 is a flowchart illustrating the steps taken by a server in implementing the invention.

### DETAILED DESCRIPTION OF THE INVENTION

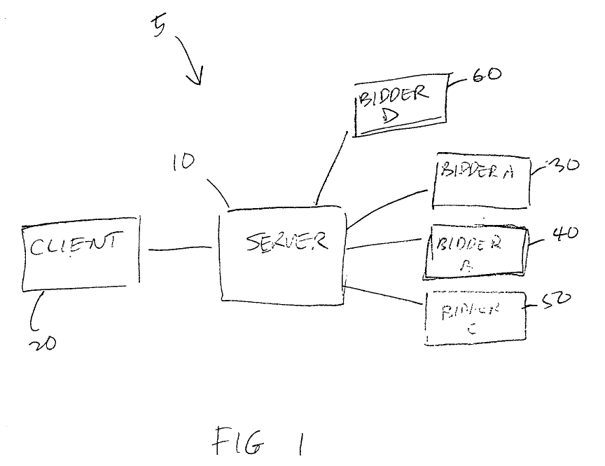

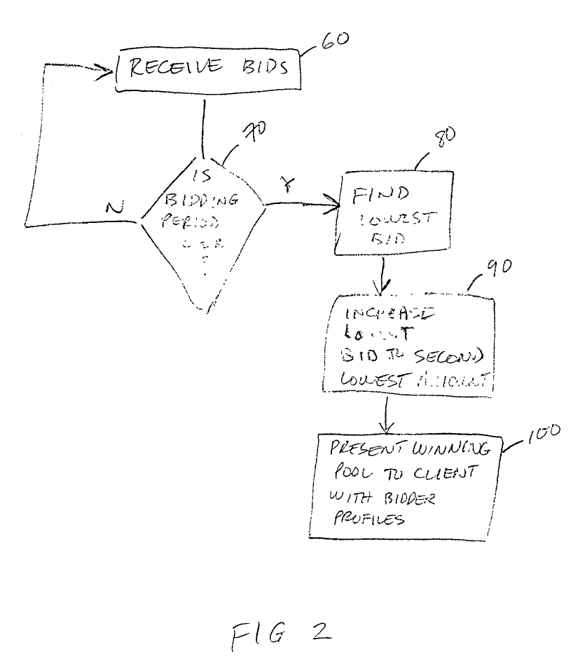

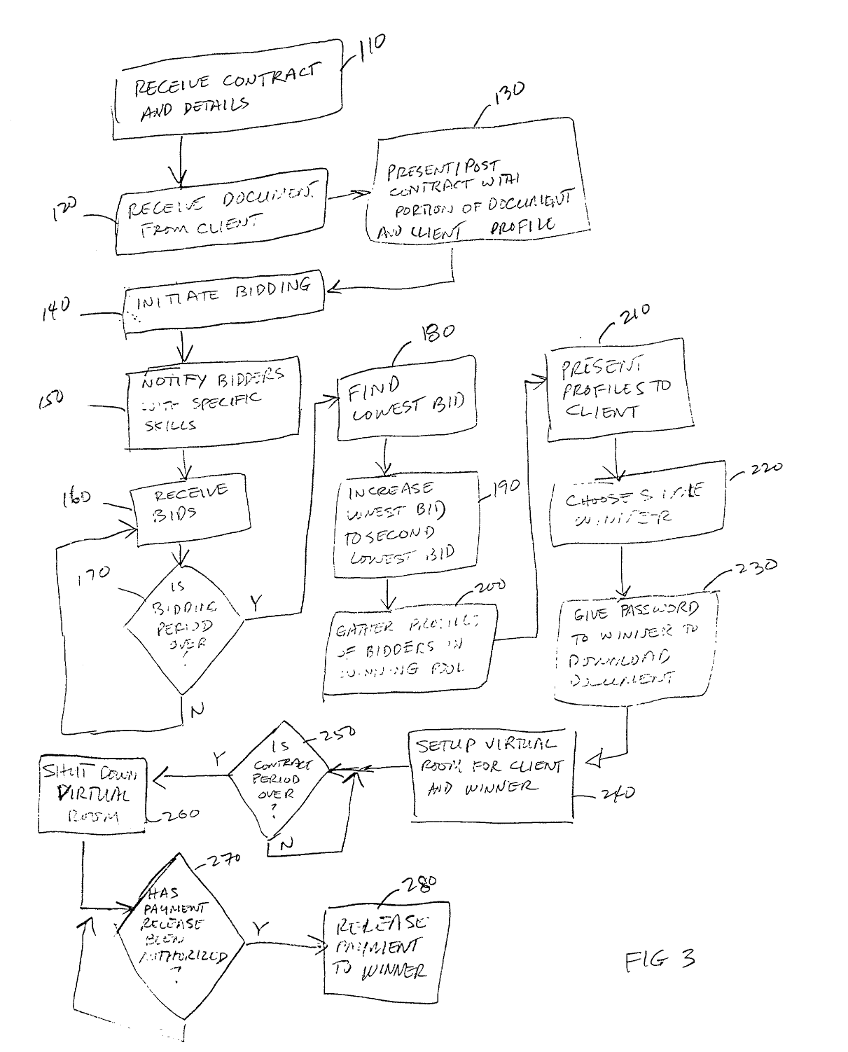

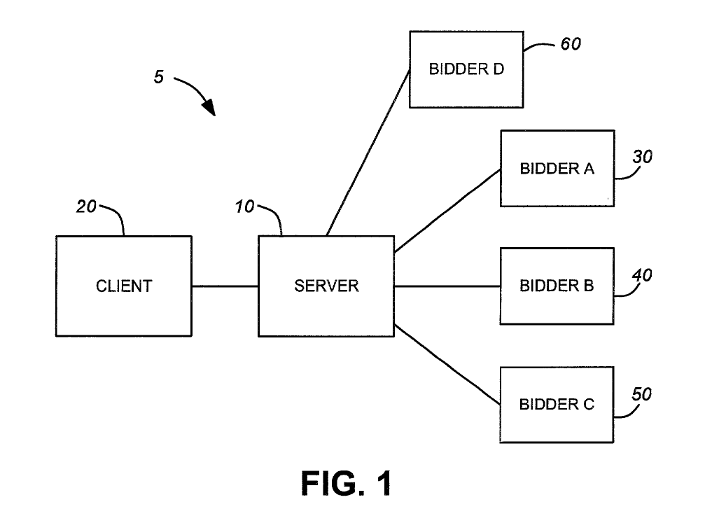

FIG. 1 illustrates a system on which an online auction system can be implemented. A server 10 is in communication with a client computer 20 along with bidder computers 30, 40, 50, 60. Bidder A uses bidder computer 30, bidder B uses bidder computer 40, bidder C uses bidder computer 50 and bidder D uses bidder computer 60. The client computer 20 sends the particulars of a contract to be bidded on to server 10. Server 10 then displays the particulars of this contract to bidders A, B, C and D. These bidders then communicate their sealed bid to the server for processing. The server 10 determines the winning pool for this contract and provides the winning bid and the profiles of the winning bid to the client.

The rationale behind the architecture in FIG. 1 is to discourage client/bidder interactions prior to the end of the bidding period. A double blind system is used where the client does not know who the bidders are and the bidders do not know who the clients are. Each client is only identified to the bidders by his profile and by any feedback posted by bidders who have completed contracts for that particular client. Similarly, bidders are only identified by their profiles and their own feedback. The profiles and their format may be dictated by the types of contracts being bid upon. As an example, if the contracts were for translation services, the client profiles can include the type of industry the client is in (medical, technical, mechanical, etc.) along with any special needs the client may have. These may include needs such as a contractor/bidder with a specific level of security clearance or background in some specific field.

Continuing with the translation example, for the bidders, their profiles may contain any special skills or skill sets they may have such as being a native speaker of a particular language, any technical background or exposure, years of experience as a translator, or types of documents previously translated.

Regarding the contract up for bids, the client's requirements for the contract are posted along with the contract. Thus, to continue with the translation example, a client would post a contract to translate a 50 page Japanese document into English. The client can then require specific qualifications for the contract such as a requirement for a native English speaker to translate the document and a requirement for a translator with a background in medicine. The client can also require a specific time frame for the contract such as that the translation will need to be done in two weeks' time. The client may therefore post any requirement he or she may have regarding the contract.

Once the contract has been posted, the client may then place a specific period during which the contract is up for bid. This bidding period depends on the client. It may be measured in days, weeks or even hours. To notify specific bidders who may have the specific skills required by the client, the client can fill out a form prior to or after posting the contract. The form can have check boxes that detail specific skill sets or requirements required by the client for the contract. Any bidder registered with the server who has the requirements as set out by the client will then be notified by e-mail that a contract suitable for him or her is up for bid. Once this potential bidder receives this e-mail, he or she can therefore log into the server to find out more details about the contract.

To bid on a specific contract, a bidder must be registered with the server. The registered bidder must submit a form to the server that details the bidder's background and/or any special skill sets the bidder may have. To facilitate this process, the bidder can be presented with a check list of what he or she may have in terms of background and/or experience. This check list may contain boxes which the registering bidder can check if, for example, the registering bidder is a native English speaker, a native Japanese speaker or whether the registering bidder has a technical background and if so, in what field.

After the potential bidder logs in and looks up the contract for bid, the registered bidder can then check the profile of the client who has put the contract up for bid. The registered bidder can also access the feedback that the client has received based on the feedback from the client profile. The potential bidder can then determine whether he or she wants to bid on the contract. If the potential bidder wishes to bid on the contract, the bidder fills out the bid form that details the rate at which the bidder is willing to execute the translation. This may be in the form of a per word rate or a per page rate, a page being defined as a specific number of words.

The server will therefore accept bids from bidders as long as the client's supplied bidding period has not expired. At the end of the bidding period the server will no longer accept bids from bidders. At this point the server will then correlate all of the validly received bids and reduce each of these bids to a common measure. This may take the form of having each bid reduced to a per page rate or a per word rate. The server will then take all of these bids and determine which bids are lowest and which bids are second lowest. The lowest bids on the common scale will then be increased in value equal to the second lowest bids. These bids, collectively known as a winning pool, will be composed of the lowest bids, increased to the second lowest bids, and the second lowest bids.

Once the winning pool is established, the server will collect the profiles of all the bidders whose bids have made it to the winning pool. The server will then present all of these profiles to the client. At this point, all of the bidders in the bidding pool are equal in the eyes of the client, in that the client only knows that all of these bidders have bid the same amount for the contract. The client can then choose a single winning bidder based on the bidder's profile provided by the server. It should be noted that when the winning pool is established, the bidders who did not make it to the winning pool are notified that they have lost the auction.

Alternatively, to randomize the process, the computer can randomly choose one of the bidders in the winning pool and present that winning bidder to the client as a sole winning bidder. Once the single winning bidder is found the rest of the bidders in the winning pool are notified that they have lost in the auction.

With the single winning bidder now determined, either by the client from the bidder profiles provided by the server or randomly determined provided by the server, the identity of the winning bidder and of the client are revealed to both the client and the winning bidder. The client and the winning bidder are allowed access to a virtual room monitored and provided by the server so that the client and the winning bidder may discuss the issues regarding the contract. This virtual room will only be available to the client and the winning bidder during the duration of the contract. It should be noted that the duration of the contract is as set up by the client when the client posts the contract up for bid. Using the virtual room provided by the server, the client and the winning bidder can determine details of the contract, such as methods of delivery, deadlines, and any other details they wish to discuss.

In conjunction with the use of a virtual room, the client and the winning bidder can both be given specific e-mail addresses and passwords or keys with which these addresses can be unlocked. These addresses will allow them to send and receive online messages from each other for the duration of the contract. Such a system would also allow them to attach documents with their messages, thereby facilitating exchanges of drafts or works in progress relating to the translation. It should be noted that, similar to the virtual room concept, such private and specific e-mail addresses are only activated and usable for the duration of the contract.

It should be noted that, in the translation example provided above, it is possible to use the server as an impartial third party in any proceedings between the client and the potential winning bidder. When the client posts the contract up for bids he includes a summary of the work. Such a summary would include the type of document to be translated, what subject field the document is related to and a brief description of the document, along with the size of the document and the deadline for the contract. Then the client may also decide to upload to the server the document to be translated. A portion of this document may then be provided to the potential bidders so that they may determine how to properly price a bid. A potential bidder, by examining the complexity, length and difficulty of the contract as shown by the portion of the document and a client posted summary of the document to be translated can therefore make a fair determination of the bid to complete the translation. After the winning bidder has been determined and approved by the client, the server can then release the whole document for translation to the winning bidder. The winning bidder may be given a specific password which will allow that bidder to download the document to be translated.

At the end of the contract, the winning bidder can upload to the server the completed translation. This completed translation can be rerouted by the server to the client. In terms of payment the client can pay the operators of the server as a third party escrow entity which will hold the funds until the contract is satisfactorily completed. Thus, the operators of the server will hold the client's payment for the contract while the contract is being performed. Once the contract is completed and the winning bidder has uploaded the translated document and once the client has received the translated document, the client can then authorize the release of funds to the winning bidder.

As an alternative payment scheme, the translator's and the client's credit card accounts can be used. When registering to use the system, both the translator and the client will have to enter their credit card numbers. Once the contract has been fulfilled, the translator can make a request for payment. With the request made and assuming no problems with the translation and with the client's authorization, the operators of the server will deduct or debit the contract amount from the client's credit card account and credit or add the same amount to the translator's credit card account. Of course, the server operators may also charge for this transaction.

If there is any dispute regarding the contract such as quality of work or timeliness of the service performed, the client can withhold authorization of payment to the winning bidder. If the issue is one of quality of work, the operators of the server can provide an extra service of proofreading the translated document to determine if it is an accurate translation of the original document from the client. As a third party arbitrator in the matter, the operators of the service can then render a judgment regarding the translation. If the client is happy with the judgment, he or she can authorize the release of funds to the winning bidder. If, on the other hand, the client is not satisfied with the judgment rendered by the operators of the server, another arbitrator agreed upon by the client and the winning bidder can arbitrate the matter.

It should be noted that the details of the above system may be changed in accordance with the implementation. As an example, the portion of the document to be translated which is visible to the bidders may or may not be chosen by the client. Furthermore, the client may be continuously notified of bidders and their profiles as bids come in for a specific contract. By using this method the client can continuously monitor the type of bidders posting bids for his or her contract. It should also be noted that bidders are not to be notified of how many other bids are being entered for a specific contract they are bidding for or how much the other bids are. It would be clear that none of the bid amounts entered are ever revealed to the client except for the second lowest bid. The client should not be appraised of any details regarding the bidding amounts until the end of the auction.

In the event that all of the bids received by the bidder for a specific contract are unacceptable to the client, for example, such as because they are either too high or the client does not approve of any of the winning bidders, the client can extend the bid period or the client can enter into negotiations with a specific bidder. While this alternative seems to obviate the need for a bidding process, it does allow the client to determine the quality and type of bidders for his contract and to determine what is the going market rate for such a contract.

With regard to the virtual room provided for the client and the winning bidder, access to this virtual room is, as noted above, limited to only the client and the winning bidder. It should be noted that such access is also only limited to the period during which the contract is in force and the client and winning bidder are only allowed to discuss the single document that is the subject of the contract in place. To facilitate the usefulness of the virtual room, both the client and the winning bidder are able to upload the edited document to the server. This edited document can then be viewed by both parties simultaneously. To facilitate discussion, either or both text and voice communications between the client and bidder can be available in a separate window. Thus, one window could have the document being discussed, while another text window on the side could include the comments by the client and the winning bidder.

As an added feature of the virtual meeting room, the client and the winning bidder may be given access to a dedicated video link between the two. Both parties will thus be allowed access to a dedicated Internet link that allows video conferencing between the two. Of course, each must have the proper equipment to take advantage of such a feature but, assuming they both have such equipment, a video window can be opened adjacent the document being translated so that each party can view not only the document but each other as well.

Again, as noted above, once the finished product has been sent to the client and the client has approved of the text, the contract is over and the client can then authorize payment to the winning bidder. It should be clear that once this point is reached, neither the client nor the winning bidder has access to the virtual room.

With the contract over, both the winning bidder and the client are requested to rate each other in terms of the contract just finished. The client can, therefore, provide an evaluation of the winning bidder in terms of the speed of the work, the professionalism of the winning bidder and client's satisfaction level with the translated document. This feedback will then become part of the winning bidder's profile. The winning bidder, for his part, will be asked to provide feedback on the client on such matters as the ease with which the translator is able to work with the client, and if there was any difficulty with the client releasing payment. This winning bidder provided feedback will then become part of the client's profile.

To facilitate future transactions between clients and bidders, the client can be given the option of posting the document summary after the contract is completed. The summary would now include the length of time required to translate it, a brief description of the winning bidder and the agreed upon winning bid or payment rate. This database of past completed contracts will then be available to future clients and bidders to facilitate the formulation of fair bids for future work.

While the above process contemplates a lowest bid and a second lowest bid, there may be occasions where bid amounts are tied. For example, there may be two lowest winning bids and a single second lowest winning bid. In this situation, one option would be to raise the two tied lowest winning bids to the amount of the second lowest winning bid and have a winning pool of three bidders. These three bidders would therefore be the bidder with the second lowest winning bid and two lowest winning bidders. Alternatively, the two lowest winning bids may constitute a winning pool by themselves. Regardless of how many bidders have the same bid, those bidders with the lowest winning bids would have their bids increased to the second lowest winning bid thereby providing a winning pool comprising the bidders with the second lowest winning bid and the bidders with the lowest winning bid. It should be noted that the winning pool may not necessarily constitute only two bidders, but may constitute multiple bidders.

In the beginning, when setting the conditions of the bidding, the client may be given the opportunity of determining how many bidders should there be in a bidding pool. Thus, if the client wishes three bidders in the winning pool, and there is only one bidder with the lowest bid, and only one bidder with a second lowest bid, the server can decide to include the third lowest bidder into the winning pool, along with the bidder for the second lowest bid and the bidder for the lowest bid. If this alternative was implemented, the server would then keep adding to the winning pool by going up the ladder of the lowest bids until the number of bidders in the winning pool is equal to that requested by the client. The above alternatives relate only to how bidders are added to the winning pool. Once the winning pool has been determined, the profiles of the bidders in the winning pool are, as noted above, presented to the client so the client may made a determination for the single winner.

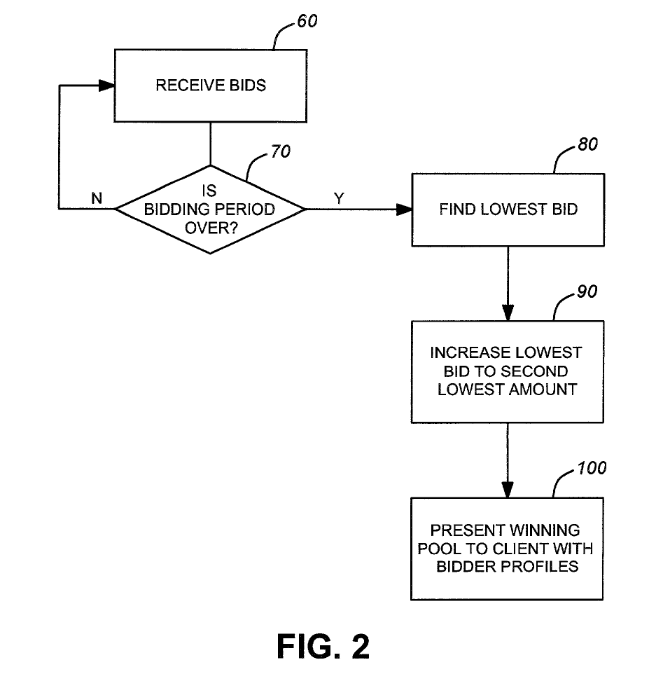

To summarize the bidding process outlined above, FIG. 2 illustrates a flow chart detailing the steps. The bidding process begins with step 60 where the server receives bids. Step 70 determines whether the bidding period is over. If the bidding period is not over, the flow chart details returning to step 60 and receiving further bids. If the bidding period is over, then step 80 is that of finding the lowest bid among the validly received bids. Step 90 is then that of increasing the lowest bid to an amount equal to that of the second lowest bid. Step 100 is that of presenting the winning pool composed of bidders who bid either the lowest or the second lowest to the client. These bidder profiles will be the basis upon which the client will choose a single winning bidder.

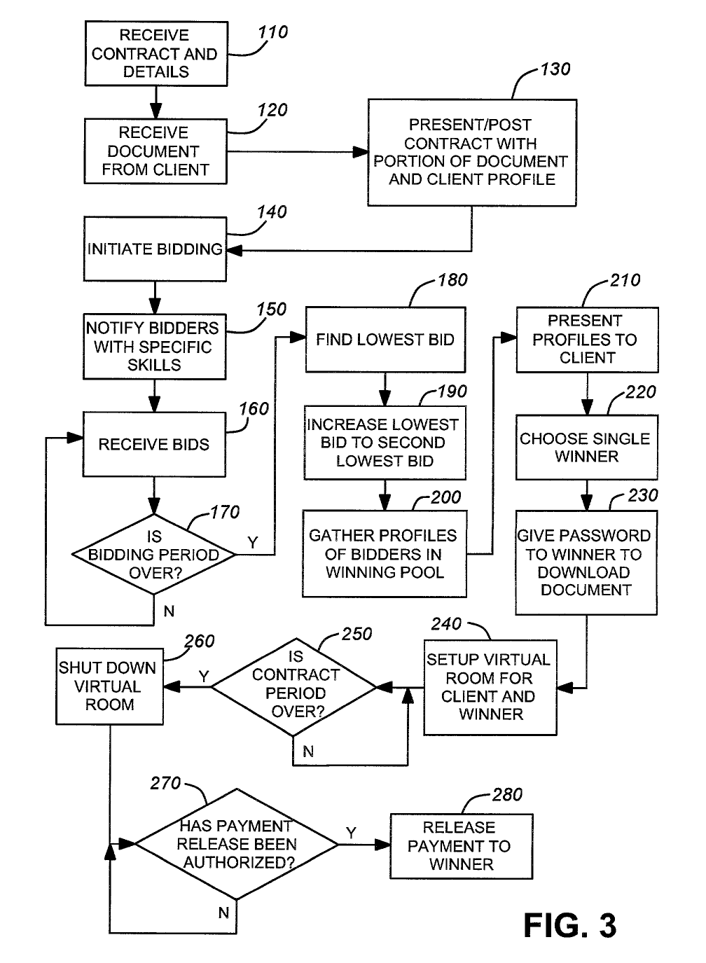

While FIG. 2 only illustrates the steps taken in the actual bidding process, FIG. 3 illustrates the steps taken by the server in the whole translation example given above. As can be seen in FIG. 3, the process begins with the server receiving a contract and the details of that contract from a client. These details can include such items as the duration of the contract, the duration of the bidding period, any reserve price, and any specific requirements the client and/or the contract may require. Step 120 is that of the server receiving the document to be translated from the client. Step 130 is that of the server presenting or posting the contract to the bidders along with a portion of the document to be translated and the profile of the client who is putting the contract up for bids. At this point, step 140, the server initiates the bidding. Step 150 has the server notifying the bidders with the specific skills that conform to the specific requirements of the contract and/or the client. This can be done through any conventional electronic or computerized means. Step 160 for the server is that of receiving the bids from the prospective bidders. Step 170 is that of the server determining if the bidding period is over as set by the client in step 110. If the bidding period is not over, then the server returns to step 160 and receives further bids. Once the bidding period is over, step 180 is that of finding the lowest bids among the validly received bids. Step 190 is that of increasing the lowest bid to a value equal to the second lowest bid, thereby creating a winning pool. Step 200 is that of gathering the profiles of the bidders in the winning pool for presentation to the client (step 210).

With the bidders in the winning pool having their profiles presented to the client, the client then chooses a winner (step 220). It should be noted that step 220 may be accomplished by the server itself and not by the client. If this alternative is chosen the server can randomly select one of the winning bidders in the winning pool as the single winning bidder. It is also at this point that the bidders who have lost the auction are notified. With the winner now chosen, step 230 is that of providing the single chosen winner with a password so he or she can download the document to be translated. Step 240 is that of the server setting up a virtual room (or, alternatively, setting up the private e-mail accounts) for the client and the winner so that they may discuss any issues relating to the translation. Step 250 is that of determining if the contract period is over. If not, then the server enters a loop that it follows until the contract period is over. Once the contract period is over, the server shuts down the virtual room, step 260. While the server is within this loop, the translator can upload the finished document, discuss the document with the client, and/or correct the translated document. Step 270 determines whether the client has authorized the release of payment to the winning bidder. If not, then the server waits until the client has done so. Once the client has authorized payment, the final step 280 is that of releasing the payment to the winner.

It should be noted that while the above examples and flowcharts details a scenario where the item or service up for bids is for translation contracts, any contract for services or any auction in which the lowest bid would otherwise win, is amenable to the process as outlined above. Thus, any contracts for services in which a sealed bid auction is used to determine to whom to award contracts can be the subject of the auction.

To clarify, this system may be used for processes such as the tendering, bidding and awarding of Government building contracts, suppliers vying for the right to supply contracts or subcontractors, manufacturers bidding to supply retailers or the outsourcing of manpower.

It should also be noted that the process as outlined above is ideal for implementation over the Internet for any type of service not requiring a specific physical presence. The bidders and the client can be remotely located from the server and each of the bidders and/or client can log onto the server through the Internet. By using this system structure, clients can be located in an area geographically remote from either translators and/or servers. Thus, a client located in Tokyo can place up for bids a document for translation with a server located in the United States, and bidders can be located in Europe or South America. By using the Internet as the process as outlined above, contractors need not be physically close to clients and/or what is essentially a contract broker. The above system and its implementation can therefore provide opportunities to bidders that were not available before.

A person understanding the above-described invention may now conceive of alternative designs, using the principles described herein. All such designs which fall within the scope of the claims appended hereto are considered to be part of the present invention.

We claim:

1. A method of conducting a sealed bid auction, the method comprising:
(a) receiving the sealed bids prior to a bidding deadline;
(b) at or after said bidding deadline, creating a winner pool by:
(b1) determining which of said sealed bids is lowest,
(b2) determining which of said sealed bids is second lowest,
(b3) increasing lowest bids to an amount equal to second lowest bids, said winner pool being composed of said second lowest bids and said increased lowest bids,
(c) choosing a single winner from said winner pool.

2. A method as in claim 1 wherein said auction is an online auction.

3. A method as in claim 1 wherein said auction is for a contract for translation services.

4. A method of conducting a sealed bid auction, the method comprising:
(a) receiving the sealed bids prior to a bidding deadline;
(b) at or after said bidding deadline, creating a winner pool by:
(b1) determining which of said sealed bids is highest,
(b2) determining which of said sealed bids is record highest,
(b3) decreasing highest bids to an amount equal to second highest bids, said winner pool being composed of said second highest bids and said decreased highest bids,
(c) choosing a single winner from said winner pool.

5. A method as in claim 4 wherein said auction is an online auction.

6. A method as in claim 4 wherein said auction is for a contract for goods, rights, or property.

7. A method as in claim 3 wherein said auction is an online auction.

8. A method as in claim 7 wherein a third party receives payment for said contract and said third party only releases payment for said contract when said contract has been completed.

9. An online system for conducting lowest sealed bid auctions, the system comprising:
a computer server for monitoring and executing a lowest sealed bid auction,
a plurality of bidder computers in communication with said server, each of said bidder computers transmitting at least one bid to said server for said auction,
at least one client computer in communication with said server, said at least one client computer providing said server computer data regarding said auction and data regarding an item or contract up for bids,
wherein
said server creates a winner pool from said bidder computers based on amounts of bids received from said bidder computers and said client computer chooses an auction winner from said winner pool, and
each bidder computer is unaware of the bid amounts transmitted by other bidder computers.

10. A computer server for conducting an online sealed bid auction, said server containing computer readable and computer executable code for:
(a) receiving sealed bids from bidder computers prior to a bidding deadline,
(b) at or after said bidding deadline, creating a winner pool by:
(b1) determining which of said sealed bids is lowest,
(b2) determining which of said sealed bids is second lowest,
(b3) increasing lowest bids to an amount equal to second lowest bids, said winner pool being comprised of said second lowest bids and said increased lowest bids,
(c) choosing a single winner from said winner pool.

11. A computer server as in claim 10 wherein said auction is for a contract for translation services.

12. A computer server as in claim 10 wherein step (c) includes presenting a client computer with profiles of bidder computers in the winner pool and receiving an indication from said client computer which of said bidder computers in the winning pool is the single winner.

13. A method as in claim 7 further including providing a virtual room for said single winner and a client providing the contract, said virtual room being available to said single winner and said client only for a duration of said contact such that said client and said single winner can discuss details of said contract with each other while logged into said virtual room.

14. A method as in claim 2 further including providing a virtual room for said single winner and a client providing the contract, said virtual room being available to said single winner and said client only for a duration of said contact such that said client and said single winner can discuss details of said contract with each other while logged into said virtual room.

15. A server as in claim 10 wherein said server further includes computer readable and executable code for providing a virtual room, further including providing a virtual room for said single winner and a client providing the contract, said virtual room being available to said single winner and said client only for a duration of said contact such that said client and said single winner can discuss details of said contract with each other while logged into said virtual room.

16. A method as in claim 7 further including providing e-mail addresses for said single winner and a client providing the contract such that said single winner and said client can communicate through said e-mail addresses, said e-mail addresses being available to said single winner and said client for a duration fo said contract.

17. A computer server for conducting an online sealed bid auction, said server containing computer readable and computer executable code for:
(a) receiving sealed bids from bidder computers prior to a bidding deadline,
(b) at or after said bidding deadline, creating a winner pool from said bidder computers based on amounts of bids received from said bidder computers,
(c) presenting profiles of bidder computers to a client computer providing said computer server data regarding said auction and data regarding an item or contract up for bids,
(d) receiving a determination from said client computer of a single winner from said winner pool.
